(19) United States
(12) Patent Application Publication
(10) Pub. No.: US 2008/0202617 A1
(43) Pub. Date: Aug. 28, 2008

(54) AIR SUPPLY PIPE

(76) Inventor: Jung-Hyun BAEK, Seoul-City (KR)

Correspondence Address: CANTOR COLBURN, LLP, 20 Church Street, 22nd Floor, Hartford, CT, 06103, US

(21) Appl. No.: 11/679,293

(22) Filed: Feb. 27, 2007

(51) Int. Cl. F16L 11/00

(52) U.S. Cl. 138/118

(57) ABSTRACT

The present invention relates, in general, to an air supply device, which supplies fresh atmospheric air to an air conditioning system, such as an air purifier, an air conditioner, a heater and/or a cooler that is installed in a ceiling of a building. More particularly, the present invention relates to an air supply device, which includes an air supply pipe having a double pipe structure and constituting a passage for guiding atmospheric air to the air conditioning system. Described in detail, the present invention provides an air supply device, which includes an air inlet panel (3) mounted on an outer wall (1) of a building, and an air supply pipe (5) connected at a first end thereof to the air inlet panel (3) and connected at a second end thereof to an air conditioning system (4), such as an air purifier, an air conditioner, a heater and/or a cooler that is installed in a ceiling (2) of the building, thus supplying fresh atmospheric air to a room. A flexible pipe (6) is installed in the air supply pipe (5) such that a first end of the flexible pipe (6) is bent outwards from the air supply pipe (5) and is fixed using a fastening member (7), and a second end of the flexible pipe is connected to the air conditioning system (4). Thus, when the interior of the flexible pipe becomes contaminated with foreign substances, the flexible pipe can be easily replaced with a new one.

### BACKGROUND OF THE INVENTION

1. Field of the Invention

The present invention relates, in general, to an air supply device, which supplies fresh atmospheric air to an air conditioning system, such as an air purifier, an air conditioner, a heater and/or a cooler that is installed in a ceiling of a building, and more particularly, to an air supply device, which comprises an air supply pipe having a double pipe structure and constituting a passage for guiding atmospheric air to the air conditioning system. Described in detail, the present invention relates to an air supply device, which comprises an air inlet panel that is mounted on an outer wall of a building, and a plurality of air supply pipes connected at first ends thereof to the air inlet panel and connected at second ends thereof to an air conditioning system, such as an air purifier, an air conditioner, a heater and/or a cooler, installed in a ceiling of the building, thus supplying fresh atmospheric air to a room, in which a flexible pipe is installed in each of the air supply pipes, so that, when the interior of the flexible pipe becomes contaminated with foreign substances, the flexible pipe can be easily replaced with a new one.

2. Description of the Related Art

In recent years, to efficiently use indoor space and improve the appearance of a room, an air conditioning system, such as an air purifier, an air conditioner, a heater and/or a cooler, is installed in the ceiling. The air conditioning system may heat or cool indoor air while circulating the indoor air.

In large office buildings, a duct is connected to an air conditioning system, which purifies, heats and/or cools the air in a room, so that the air conditioning system can purify contaminated indoor air and heat and cool the air in the room, while the contaminated indoor air is exhausted to the atmosphere and fresh atmospheric air is supplied to the air conditioning system through the duct.

However, the conventional air conditioning system for large office buildings has a complex construction, requires excessive money to install in a building, and incurs high maintenance expenses, so that the system has not been preferred for use in an apartment house, a small building or a private residence.

Thus, when indoor air of an apartment house, a small building or a private residence becomes contaminated, windows are opened to circulate air. However, in recent years, windows of buildings have been designed to be airtight type to prevent noise and increase the thermal efficiency of buildings, and thus it may be impossible to ventilate rooms in some buildings.

Further, when windows are opened to ventilate rooms of a building, there may be no problem in spring or autumn, but opening windows for ventilating the rooms in summer or winter is problematic in that the thermal efficiency of the building is greatly reduced due to the big difference between indoor and outdoor temperatures.

Thus, in the related art, to guide fresh atmospheric air to rooms of an apartment house, a small building or a private residence and thus ventilate the rooms without opening windows, an air supply pipe may be installed in the ceiling of each room such that the first end of the pipe is connected to an air inlet panel, which is installed outside a building, and the second end is connected to an air conditioning system, such as an air purifier, an air conditioner, a heater and/or a cooler. In the above case, fresh atmospheric air may flow into the rooms by way of the air purifier, air conditioner, heater and/or cooler. However, after atmospheric air has been guided into the rooms through the air supply pipes for a lengthy period of time, the interior of the pipes may become contaminated with foreign substances, such as dust.

The conventional air supply pipes are made of metal or plastic pipes having small diameters, for example, about 150 mm or less, so that it is impossible to clean the interior of the contaminated pipes. Thus, when the conventional air supply pipes become contaminated with foreign substances, such as dust, the existing pipes must be replaced with new ones, thus increasing the maintenance cost of the air conditioning system. Further, most conventional air supply pipes are installed in walls and ceilings of buildings, so that it is not easy to replace the existing pipes with new ones.

### SUMMARY OF THE INVENTION

Accordingly, the present invention has been devised in consideration of the aforementioned problems and situations, and it is an object of the present invention to provide an air supply pipe, which supplies fresh atmospheric air to an air conditioning system, such as an air purifier, an air conditioner, a heater and/or a cooler installed in the ceiling of a room, in which a flexible pipe is installed in the air supply pipe, so that, when the interior of the flexible pipe becomes contaminated with foreign substances, such as dust, the flexible pipe is easily replaced with a new one, thus feeding fresh air to the room and reducing the maintenance cost of the air conditioning system.

In order to achieve the above described advantageous effects and objects, in accordance with the present invention, there is provided an air supply pipe of an air supply device, the air supply device comprising an air inlet panel that is mounted on an outer wall of a building, and a plurality of air supply pipes connected at first ends thereof to the air inlet panel and connected at second ends thereof to an air conditioning system, such as an air purifier, an air conditioner, a heater and/or a cooler that is installed in a ceiling of the building, thus supplying fresh atmospheric air to a room, wherein a flexible pipe is installed in each of the air supply pipes so that, when the interior of the flexible pipe becomes contaminated with foreign substances, the flexible pipe can be easily replaced with a new one.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a side view illustrating the construction of an air supply device according to an embodiment of the present invention; and

FIG. 2 is a sectional view illustrating the construction of an air supply pipe according to an embodiment of the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

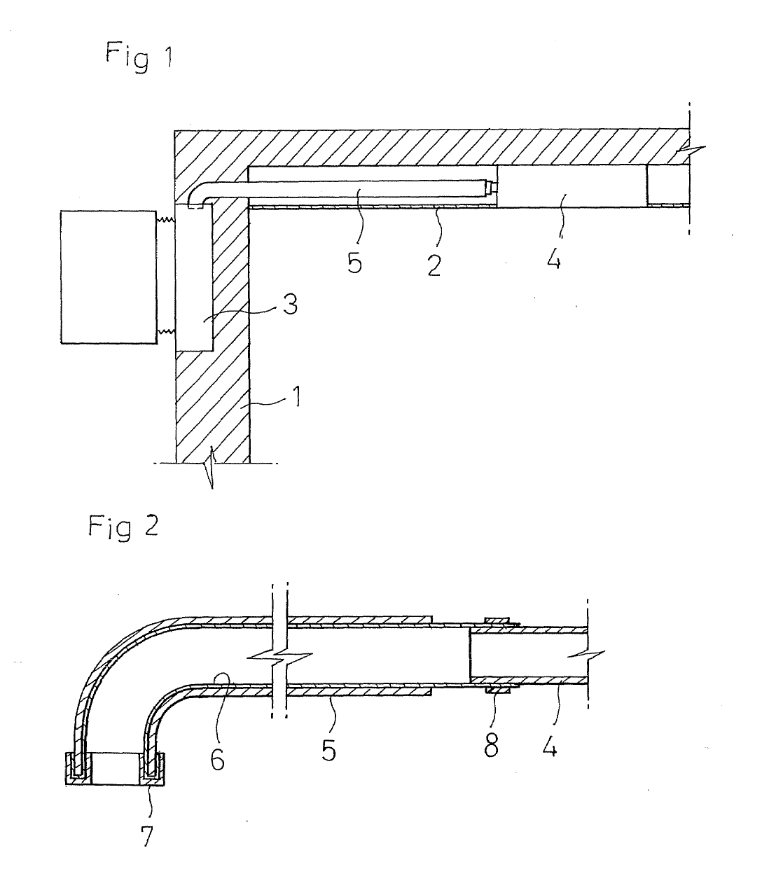

FIG. 1 is a side view illustrating the construction of an air supply device according to an embodiment of the present invention. FIG. 2 is a sectional view illustrating the construction of an air supply pipe according to an embodiment of the present invention.

As shown in the drawings, the air supply device comprises an air inlet panel 3, which is mounted on an outer wall 1 of a building, and an air conditioning system 4, such as an air purifier, an air conditioner, a heater and/or a cooler which is installed in a ceiling 2 of the building. An air supply pipe 5 is installed in the ceiling 2 of the building. The air supply pipe 5, which connects the air conditioning system 4 to the panel 3, is provided with a flexible pipe 6 therein. The first end of the flexible pipe 6 is bent outwards from the pipe 5 and is fixed using a fastening member 7. The second end of the flexible pipe 6 is connected to the air conditioning system 4.

In other words, when the flexible pipe 6 is connected to the air conditioning system, which is installed in the ceiling 2, the flexible pipe 6 is fitted over an air inlet port of the air conditioning system 4 and is fastened thereto using a band 8. The flexible pipe 6 comprises a thin vinyl pipe, with an iron coil provided in the thin vinyl pipe, so that the flexible pipe 6 is prevented from being shrunk inwards in a radial direction while air flows to the air conditioning system 4 through the pipe 5.

After atmospheric air has been guided to the air conditioning system through the pipe 5 of the present invention for a lengthy period of time and thus the interior of the flexible pipe 6 becomes contaminated, one end of the flexible pipe 6 is pulled after both the fastening member 7 and the band 8 are removed, so that the flexible pipe 5 can be removed. When a new flexible pipe is installed in the pipe 5, a steel wire may be inserted into one end of the pipe 5 in one direction until the front end of the steel wire projects outside the opposite end of the pipe 5. Thereafter, the new flexible pipe is locked to the projecting end of the steel wire and the steel wire is pulled in the opposite direction, so that the new flexible pipe can be installed in the pipe 5. Alternatively, a rope may be placed between the flexible pipe and the pipe 5. In the above state, when it is desired to replace a contaminated flexible pipe with a new flexible pipe, opposite ends of the contaminated flexible pipe are locked to respective ends of the rope and, at the same time, the new flexible pipe is locked to the first end of the rope prior to easily replacing the contaminated flexible pipe with the new flexible pipe. After the flexible pipe 6 has been installed in the pipe 5, the first end of the new flexible pipe 6 is fastened to the pipe 5 using a fastening member 7, while the second end of the flexible pipe 6 is fitted over the air inlet port of the air conditioning system 4 and is fastened thereto using a band 8.

In the above description, the air supply pipe according to the present invention is connected at the first end thereof to the panel 3 and is connected at the second end thereof to the air conditioner 4. However, when one air conditioning system is installed at a predetermined place on a floor inside a room and supplies heated or cooled air to several rooms, the first end of the pipe may be connected to the air conditioning system, while the second end of the pipe may be connected to an air outlet grille of the air conditioning system. In other words, the present invention is preferably used in an air supply pipe or an air supply duct, which supplies air into a room without branching at an intermediate portion thereof. Further, although the embodiment of the present invention has been described for a ceiling-embedded type air conditioning system and a ceiling-embedded type air supply pipe, it should be understood that the present invention may be adapted to a wall-embedded type air conditioning system and a wall-embedded type air supply pipe without affecting the functioning of the present invention.

The present invention provides an air supply pipe, which supplies fresh atmospheric air to an air conditioning system, such as an air purifier, an air conditioner, a heater and/or a cooler, which is installed in the ceiling of a room, in which a flexible pipe is installed in the air supply pipe, so that, when the interior of the flexible pipe becomes contaminated with foreign substances, such as dust, the flexible pipe can be easily replaced with a new one, thus feeding fresh air into the room and reducing the maintenance cost of the air conditioning system.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An air supply pipe of an air supply device, the air supply device comprising an air inlet panel installed on an outer wall of a building, an air conditioning system, such as an air purifier, an air conditioner, a heater and/or a cooler, installed in a ceiling of the building, and the air supply pipe installed in the ceiling and connecting the air conditioning system to the air inlet panel, wherein
the air supply pipe is provided with a flexible pipe therein such that a first end of the flexible pipe is bent outwards from the air supply pipe and is fixed using a fastening member, and a second end of the flexible pipe is connected to the air conditioning system, such as the air purifier, the air conditioner, the heater and/or the cooler.
